(19) United States
(12) Patent Application Publication
(10) Pub. No.: US 2011/0068987 A1
(43) Pub. Date: Mar. 24, 2011

(54) Multiband RFID tag

(75) Inventor: William N. Carr, Montclair, NJ (US)

(73) Assignee: New Jersey Microsystems. Inc, Montclair, NJ (US)

(21) Appl. No.: 12/462,428

(22) Filed: Aug. 5, 2009

(51) Int. Cl. H01Q 11/12

(52) U.S. Cl. 343/741

(57) ABSTRACT

An RFID tag communicating with a wireless reader interrogator on more than one frequency band. In one embodiment the tag contains independent sensor circuits for a ultra high frequency UHF band and a lower frequency band. The UHF antenna element used in the tag is a double-resonant antenna typically operating in the 860-960 MHz frequency range providing both near and far field sensitivity. Separate resonant antenna structures a the lower frequency band is connected in series with the UHF antenna substructure. The high frequency HF antenna element contains a coil for magnetic induction pickup of signals typically in the 7-14 MHz frequency band but can also be used for the entire spectral range 100 KHz to 100 MHz. The tag antenna is an integrated structure providing for operation in both the UHF and a lower frequency band. In a separate embodiment the tag is configured with the UHF double-dipole antenna structure only and operates in a single UHF band.

### FIELD OF THE INVENTION

This invention relates to wireless tag devices that include an integral antenna structure for scavenging power from RF incident or ambient radiation. The invention relates to wireless tags particularly those that rely on near-field inductive coupling and far-field electromagnetic coupling means of extracting power from remote RF power sources and backscattering RF signal to a remote reader.

### LIST OF FIGURES

The accompanying drawings illustrate the present invention and enable a person skilled in the art to make and use the invention.

FIG. 1 Multiband RFID sensor tag architecture

FIG. 2(a) UHF antenna substructure

FIG. 2(b) UHF antenna structure with series inductor

FIG. 3 HF antenna substructure

FIG. 4 HF and UHF antenna substructures combined

FIG. 5 HF and UHF antenna integrated into a single structure

### DESCRIPTION OF THE RELATED ART

RFID tags and systems are utilized in many different industries and have a variety of applications. The frequency band in which a particular RFID tag operates tends to dictate its physical characteristics due to design considerations including the type of antenna required, performance characteristics, and the system in which is it is intended to operate. The RFID system subject of the present invention provides a long range tag operation in the UHF band and a near field or short range for operation in the lower frequency bands including LF and HF.

Electronic devices known as passive and semipassive RFID tags are generally remotely powered by an appropriate reader interrogator device and are widely used for identification of items in warehouses, shipping containers, moving stock, and personnel identification. Those tags where the RF source is coupled into the tag by an antenna sensitive to magnetic induction fields provide a near-field response generally with a maximum range of millimeters to a few feet.

RFID tags with a backscattering data link contain additional onboard power sources including a battery, solar cell, vibratory power transducers, or other sources are designated as semipassive RFID tags.

Both passive and semipassive RFID tags are the subject of the present invention. They receive a modulated signal from the reader and also retransmit a modulated signal back to the reader by backscattering the incident RF beam carrier amplitude.

Prior art RFID tags contain antenna and other structures that limit the performance in range, spatial field pattern coverage, and performance on metal. The present invention comprises a UHF antenna providing advantages in each of the three mentioned performance criteria. The present invention comprises tags operating in multiple frequency bands.

For instance, the antenna structure in the Brown and Lawrence application US2007/0290941 permits an RFID tag with limited UHF range due to the lack of sufficient coupling efficiency and with a single resonant structure. Also this patent does not teach operation with sensitivity over the entire frequency band 100 KHz through UHF.

Another application Kodukula et al US2008/0122631 teaches an RFID tag technology that is suitable only for UHF. This application is adapted to the 860-960 MHz band of frequencies. It uses a single loop antenna and an open loop antenna in a coupled configuration. The Kodukula application does not include operation at the lower HF frequency range in addition to the UHF range subject of the present invention.

Lazo in application US 2009/0066615 describes RFID tags constructed and arranged to have two or more separate antennas that are operable in two different frequency bands with an integrated circuit configured to operate as two distinct state machines. The Lazo application does not teach integrating the two antennas and therefore does not reach a minimum footprint opportunity as is taught in the present patent. The Lazo application teaches a single integrated circuit whereby the present invention makes provision for using two separate integrated circuits, each dedicated to the frequency band of interest. The present invention as an option makes use of readily available multi-sourced RFID protocol chips including those for the 860-960 MHz band the HF bands including 13.56 MHz.

Industry integrated circuits are currently available implementing ISO 18000 communication protocols including Part 3, 4, 6, and 7 for frequency bands 13.56, 2450, 860-960, and 433 MHz, respectively. The present invention may also be used to implement tags servicing the communication protocol ISO 14443. Other protocol ICs are available for the 100 to 100 KHz range. The present invention can use any UHF protocol IC with the option of a second lower frequency band as low as 100 KHz.

None of the above mentioned patent applications utilize the double-dipole UHF antenna 203 subject of the present invention.

### DESCRIPTION OF THE INVENTION

The present invention is an RFID tag with antenna structures sensitive to (a) incident electromagnetic radiation in the UHF frequency range, and (b) magnetic induction fields in the LF and HF frequency range.

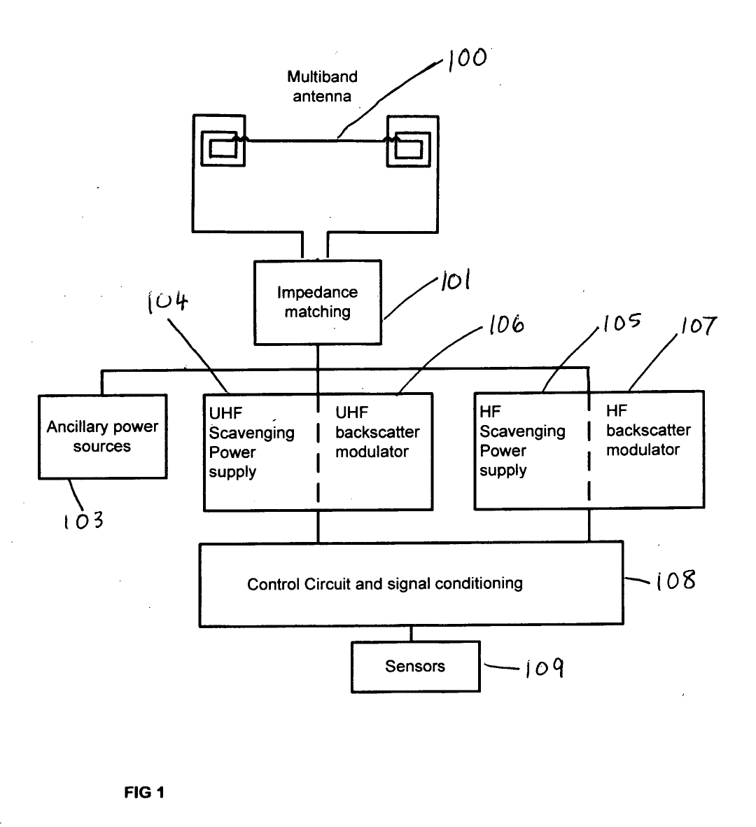

FIG. 1 is a schematic illustration of the tag architecture with the multiband antenna 100 connected through the impedance matching circuits 101 to separate UHF and lower frequency RF and communication protocol circuits. The scavenging power supplies 104, 105 supplied by the incident RF energy contains voltage multiplier circuits to increase the voltage to the circuits above the threshold required for reliable operation. This voltage typically is in the range of 1.5 to 3.3 Volts for current state of the art micropower circuitry.

The lower frequency operational range is referred to as HF in this patent. The frequencies for the application of this patent in the lower frequency range is 100 KHz up to 300 MHz. The higher frequency range for the RFID tag structures in this patent are referred to as UHF. The frequencies for the application of this patent in the upper frequency range UHF is 200 MHz up to 10 GHz.

Ancillary power sources 103 scavenging power from solar cells, vibratory MEMS, or inductive pickup from nearby AC current loops may also be designed into the tag. A local battery may provide supplementary power to the tag to supplement the scavenging power supply. The tag configuration powered only by incident RF power is a fully passive tag. The tag configuration powered with a battery or scavenged energy supplementing the RF power supply is called a semipassive tag.

The RFID tag communicates to the reader via a return link which is a backscattering of the incident RF energy. Separate backscatter modulators 106, 107 are closely integrated with the respective control circuits 108

The tag integrated circuits also include controls for data protocol, signal conditioning, and backscatter modulating the return signal. The UHF and lower frequency integrated circuit may be a monolithic circuit or it may be typically a separate circuit for each frequency band of operation.

Additionally the tag may contain one or more sensors 109 including an ADC connected to monitor switch contact closures, temperature, humidity, external impedance, shock, light and other parameters.

A nearby reader transmits control signals and data in the appropriate frequency band for storage to the tags by modulating the RF beam and with a modulation and data protocol format compatible with the tag circuits. The reader receives back response data from the tag via a backscattering of the reflected magnetic or electromagnetic field from the tag integrated antenna.

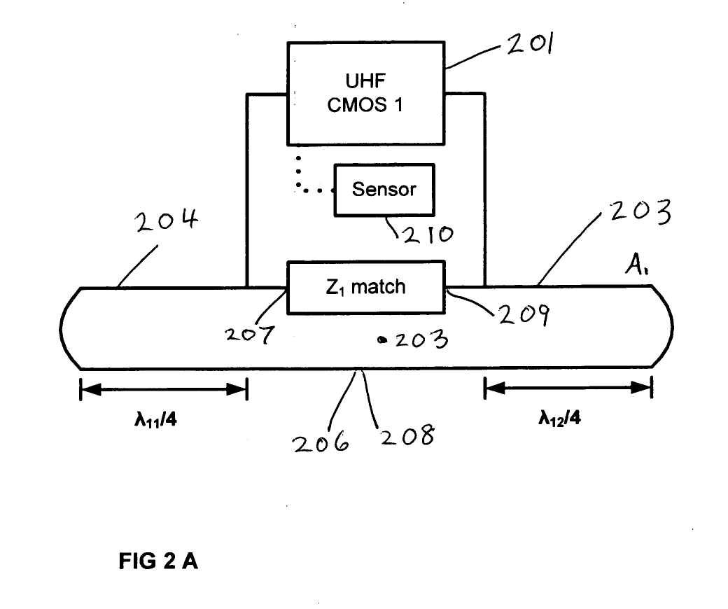

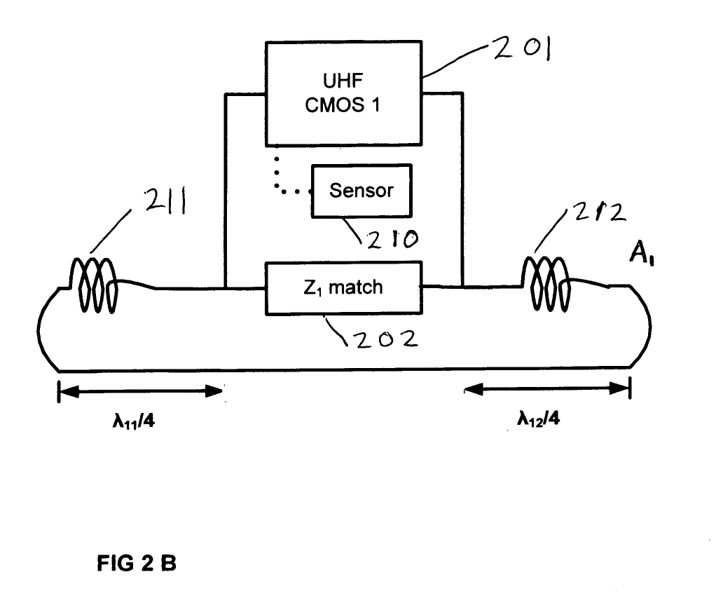

FIG. 2(a) illustrates the UHF circuit 201 with its impedance matching element 202 coupled to antenna 203. This UHF antenna A₁is a double-dipole structure providing a source impedance higher than a simple dipole and therefore is an improved impedance match to RFID micropower circuits with load resistance of over 1000 Ohms. A simple dipole antenna has a theoretical source resistive impedance at resonance frequency of 72 Ohms. FIG. 2(a) shows a left-side resonant cavity or loop 204 of approximate length 1/4 wavelength and a right-side resonant cavity or loop 203 of similar length. This double-dipole antenna structure is approximately a half wavelength in length and is used in all embodiments of the present invention. The left-side resonant structure has connection points 1 206 and 3 207. The right-side resonant structure has connection points 2 208 and 4 209. The two resonant structures comprise the double-dipole antenna. They are typically tuned to the same or approximately the same frequency band range. Connection points 1 and 2 are connected together 206, 208 and the antenna load is connected to points 3 and 4 providing a source voltage s_{T}.

For instance, a half wavelength at 915 MHz in free space is 16.4 cm. FIG. 2(b) shows series inductance elements 211, 212 that can be added to the left- and right-side UHF resonant antenna elements to achieve an effective quarter wavelength within an actual spatial distance of less than a quarter wavelength. If the left and right-side elements are tuned to different frequencies an increased bandwidth is obtained for the tag. In addition cavities with a high dielectric constant can also be used to reduce the spatial length dimension of the UHF antenna. These are shortening techniques well known to the antenna art and often are desirable to achieve smaller antenna structures.

Sensors 210 selected from among many types can be interfaced on the tag with the control circuits via an internal data bus. These sensors are selected from among micropower groups readily known to the art as including capacitive sensors, high impedance resistive sensors, and voltaic sensors such as solar cells. The sensor circuit can have a single port or multiple ports as desired to interface conveniently with the tag control and signal conditioning circuitry.

The tag is configured for single frequency operation by using the UHF antenna structure alone. The tag is configured for two-frequency operation by integrating the UHF antenna structure with a lower frequency antenna substructure.

FIG. 2(b) shows the tag connections for single UHF band operation with the quarterwave elements. In this case the addition of one or more sensors to the basic RFID circuit function is illustrated. The impedance match of the capacitive circuit load to the resonant UHF antenna is achieved by a small inductance Z₁on the order of a picoHenry. FIG. 2(b) does not describe a typical UHF RFID tag because the double-dipole RFID antenna applied to an RFID tag is unique to this invention.

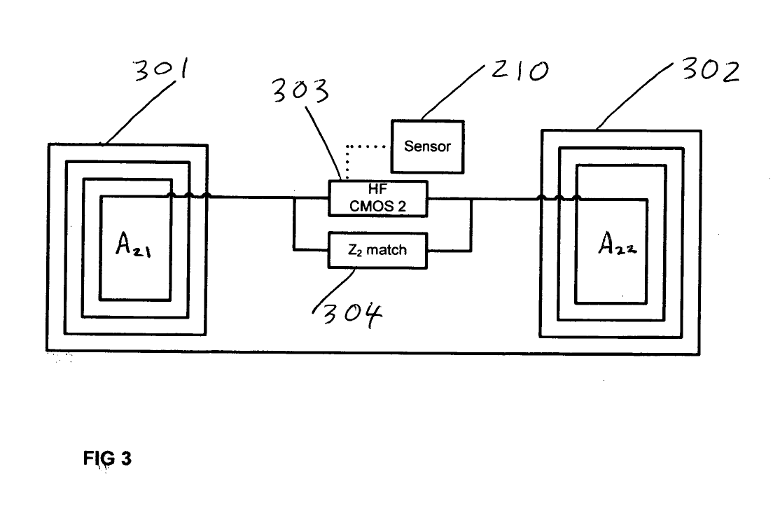

FIG. 3 shows the tag connections for single lower frequency band operation using coils A₂₁301 and A₂₂302 of wire for the induction voltage pickup. The circuitry is indicated as CMOS2 303 and a connection to an optional sensor is shown. The inductive impedance of the coil and the capacitive impedance of CMOS2 are matched (resonated) with a capacitor Z₂304. The sensor 210 is connected to an internal data bus. This is a schematic example of a lower frequency RFID tag.

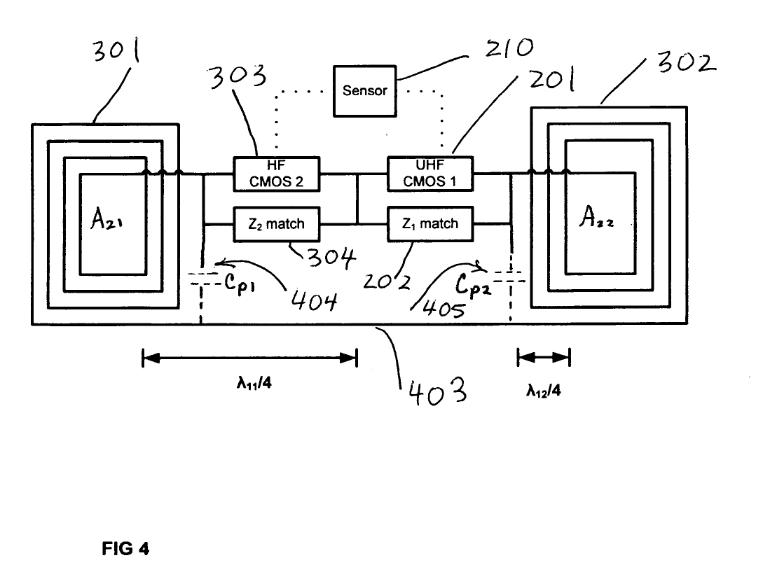

FIG. 4 illustrates how multiple band operation of the tag is achieved by connecting the UHF double-dipole and the HF induction coils 301, 302 in series and integrating their structures. The HF induction coil itself forms a portion of the double-dipole UHF antenna 303 component structure. The intrawinding capacitance Cₚ₁404 and Cₚ₂405 for the HF antenna coils in series with the relatively large capacitor Z₁202 serve as a low impedance shunt at UHF frequency and therefore provide an equivalent circuit path for the double-dipole equivalent in UHF operation. In addition the capacitive impedance matching element Z2 304 across the inductive coil additionally serves to reduce the series impedance of the coil for the UHF signal path. The inductive shunt match impedance for the UHF load serves as a low impedance path for the HF signal thereby providing an equivalent HF circuit matching that of FIG. 3 for the lower frequency operation band.

### DESCRIPTION OF PREFERRED EMBODIMENTS

The invention is further described with two preferred embodiments. The first embodiment uses only the UHF double-dipole antenna in a tag for operation in the UHF range. The second embodiment is a dual frequency tag with an integrated UHF-lower frequency antenna providing important advantages over a tag with separate UHF-lower frequency structures.

The first preferred embodiment directly implements the structure of FIG. 2(b). Double-dipole antenna elements are fabricated in a planar configuration. The effective length of the double-dipole is a wavelength. A typical UHF band for this embodiment is the 860 to 960 MHz band. The CMOS1 integrated circuit is typically an industry IC implementing the ISO 18000-6c communication protocol. An optional bus connection to the sensor provides a thermal measurement of ambient temperature. The impedance match network Z₁is a small picoHenry inductor which serves to resonate with the capacitive CMOS1 circuit element at the antenna resonant frequency. This embodiment is fabricated on a rigid or flexible substrate. The double-dipole antenna is also planar film structure formed using printed circuit etching or deposition processes. The footprint for this embodiment is 10×130 mm.

The substrate is either planer or nonplaner and includes but is not limited to one or more of polyethelene, polycarbonate, PET, polystyrene, PVC, rubber, FR4 and polysulphone materials.

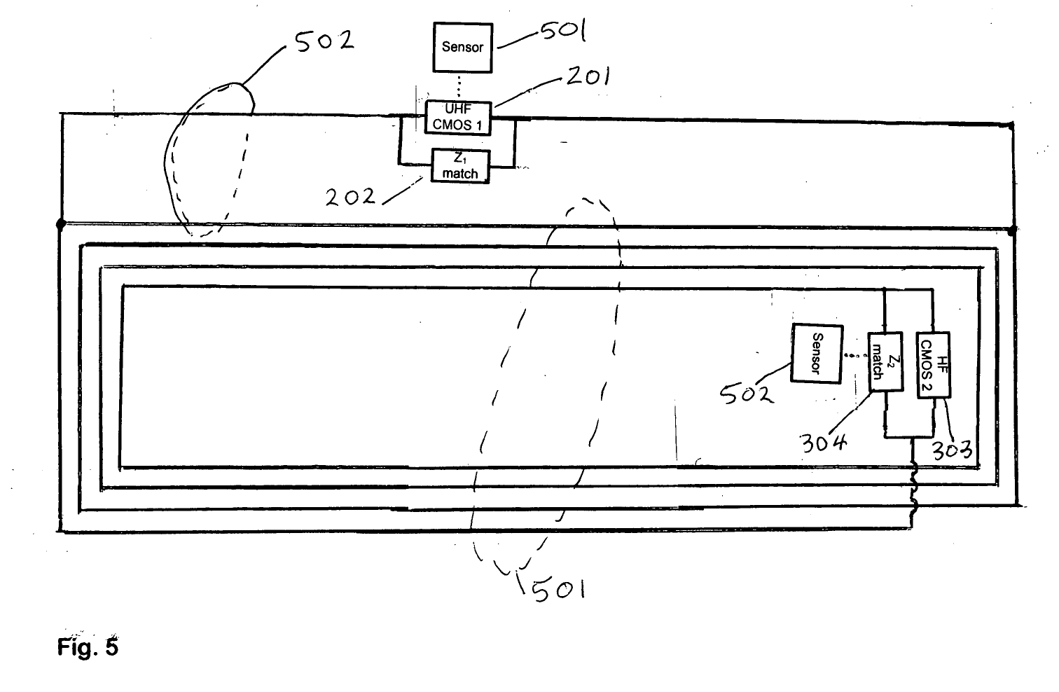

The second preferred embodiment directly implements the structure of FIG. 5. This is a dual band RFID tag with the HF antenna 501 and UHF antenna 502 structures integrated into a single structure. In this embodiment one leg of the double-dipole is shared with a portion of the HF induction coil. The separation between the two legs of the double-dipole can be reduced to less than 5 millimeters at 915 MHz thus providing a compact structure. This integrated antenna structure results in a smaller total tag footprint than is obtainable with separate, independent structures for HF and UHF. The footprint of the FIG. 5 structure as drawn can also be reduced further by placement of the UHF antenna inside the HF antenna loop. The footprint for this embodiment is 40×130 mm.

More importantly in this embodiment, the integrated structure reduces the lossy interaction that would obtain between HF and UHF structures by integrating the HF and UHF structures together. The entire HF antenna coil loop effectively becomes one leg of the UHF double-dipole antenna. When HF and UHF structures are placed independently and in close proximity there is an undesirable reduction in physical range which is overcome in the FIG. 5 configuration.

This second embodiment can include an underlying parallel-positioned thin metal sheet or film spaced at least 10 mm from the plane of the UHF and HF antennas. The thin metal sheet provides an enhancement of the UHF electromagnetic field at the UHF antenna with a resulting increase in UHF range, and also it provides an electrostatic shielding from potential underlying metal which otherwise absorbs UHF signal strongly. An underlying metal sheet or film does reduce the range obtainable with the HF antenna, but the trade-off against the advantages provided to the UHF antenna are worthwhile for many applications.

The HF and UHF match network and CMOS circuits are similar to those of FIG. 4 but are separated physically. The sensor for the UHF circuit can be shared with the HF circuit via a common bus, or sensors can be designed into the HF and UHF circuits separately. This embodiment is fabricated on a flexible substrate, but it can also be designed into a printed circuit board substrate such as FR4.

While various embodiments of the present invention have been described above, it should be understood that they have been presented by way of example only, and not limited as such. It will be apparent to persons skilled in the relevant art that various changes in

What is claimed is:

1. An RFID tag comprised of circuits for UHF and a second lower frequency operation with an RF scavenging power supply, a state machine for communication protocol, a first antenna substructure for UHF comprising:
a first electromagnetically-resonant structure with a first band of resonance;
a second electromagnetically-resonant structure with a second band of resonance;
a mechanical mount for maintaining the first structure in a fixed position relative to the second structure;
an electrical connection between a first connection point on the first structure and a second connection point on the second structure; and
an input-output port comprising a third connection point on the first structure and a fourth connection point on the second structure;
wherein a portion of the first band of resonance and a portion of the second band of resonance overlap over a common band;
wherein the antenna, in response to an electromagnetic signal within the common band, generates:
(i) a first electrical signal, s₁, between the third connection point and the first connection point,
(ii) a second electrical signal, s₂, between the second connection point and the fourth connection point, and
(iii) a third electrical signal, s_{T}, between the third connection point and the fourth connection point;
wherein the amplitude of the third electrical signal, max[|s_{T}|], is larger than the amplitude, max[|s₁|], of the first electrical signal whenever the direction of arrival and the polarization of the electromagnetic signal fall within a first subset, A₁, of all possible directions of arrival and polarizations;
wherein the amplitude of the third electrical signal, max[|s_{T}|], is larger than the amplitude, max[|s_{T}|], of the second electrical signal whenever the direction of arrival and the polarization of the electromagnetic signal fall within a second subset, A₂, of all possible directions of arrivals and polarizations; and
wherein the intersection of the first subset and the second subset, A₁∩A₂, comprises more than one-half of all possible directions of arrivals and polarization
wherein the third electrical signal, max |s_{T}|, is connected to UHF matching impedance and integrated load circuits
and a second antenna structure for lower frequency comprised of an induction coil structure with elements of both antenna structures mutually shared
wherein the induction coil is connected to a lower frequency matching impedance and integrated load circuits.

2. The tag of claim 1 where the double-dipole antenna structure is comprised of two quarter wavelength resonant cavities on a rigid or flexible substrate.

3. The tag of claim 1 where one or more of the dipole antennas supplies energy to an RF scavenging power supply including a voltage multiplier circuit.

4. The tag of claim 1 where the RF circuits are matched in impedance to the UHF and lower frequency antenna structures with an impedance matching network.

5. The tag of claim 1 where the RF scavenging power supply is supplemented with a local source of power including a battery, solar cells, vibratory MEMS, or inductive pickup from nearby AC current loops.

6. The tag of claim 1 where one or more of the RF circuits is interfaced to or includes sensors for switch contact closures, temperature, humidity, external impedance, shock, light, or other environmental parameters.

7. The device of claim 1 where the quarter wave resonant dipole structures are 1 to 20 mm in width and structured within a single plane conformal to an underlying surface.

8. The device of claim 1 where dielectric of the quarterwave resonant UHF cavities and the substrate are either planar or nonplaner and include but are not limited to one or more of the polyethelene, polycarbonate, PET, polystyrene, PVC, rubber, FR4, and polysulphone.

9. The device of claim 1 where the UHF frequency band is within the range 860 to 960 MHz.

10. The device of claim 1 where the lower frequency band includes operation at 13.56 MHz.

11. An RFID tag comprised of circuits for UHF with an RF scavenging power supply, state machine for communication protocol, and a planar double-dipole antenna structure.

12. The device of claim 11 where the double-dipole antenna is arranged in a planer configuration on a rigid or flexible substrate.

13. The tag of claim 1 where the RF scavenging power supply is supplemented with a local source of power including a battery, solar cells, vibratory MEMS, or inductive pickup from nearby AC current loops.

14. The tag of claim 11 where one or more of the RF circuits is interfaced to or includes sensors for The tag of claim 1 where one or more of the RF circuits is interfaced to or includes sensors for switch contact closures, temperature, humidity, external impedance, shock, light, or other environmental parameters.

15. The device of claim 11 where the quarter wave resonant dipole structures are 1 to 20 mm in width and structured within a single plane conformal to an underlying surface.

16. The device of claim 11 where dielectric of the quarterwave resonant UHF cavities and the tag substrate are either planar or nonplaner and include but are not limited to one or more of the polyethelene, polycarbonate, PET, polystyrene, PVC, rubber, and polysulphone.

17. The device of claim 11 where the UHF frequency band is within the range 860 to 960 MHz.

18. The device of claim 11 where appropriate protocols selected from among the ISO 18000 standards and the ISO 14444/15693 standard are implemented.
